(19) United States
(12) Patent Application Publication
(10) Pub. No.: US 2021/0001607 A1
(43) Pub. Date: Jan. 7, 2021

(54) MULTI-LAYERED STRUCTURE FOR THE REALIZATION OF A FLOOR COVERING WITH SOUND-INSULATING PROPERTIES

(71) Applicant: Gerflor, Villeurbanne (FR)

(72) Inventor: Nicolas CHABAN, Saint Restitut (FR)

(73) Assignee: Gerflor, Villeurbanne (FR)

(21) Appl. No.: 16/917,979

(22) Filed: Jul. 1, 2020

(30) Foreign Application Priority Data
Jul. 1, 2019 (FR) 1907276

(51) Int. Cl. B32B 27/08

(52) U.S. Cl. CPC B32B 27/08; B32B 2471/00; B32B 2307/54; B32B 2266/025; B32B 2307/72; B32B 2327/06; B32B 2307/732

(57) ABSTRACT

The invention relates to a multilayer structure (1) for producing a floor or wall covering, the structure comprising at least one backing layer (2) made of crosslinked polyolefin foam, giving the structure sound-insulating properties, the backing layer (2) having a lower face intended to be bonded to the floor or wall, and an upper face bonded to an upper layer (3) produced from a plastic material, linoleum or rubber.

According to the invention, at least one of the faces of the backing layer (2) has a surface tension of greater than or equal to 40 mN/m.

### RELATED APPLICATION

This application claims the benefit of priority of France Patent Application No. 1907276 filed on Jul. 1, 2019, the contents of which are incorporated herein by reference in their entirety.

### FIELD AND BACKGROUND OF THE INVENTION

The present invention relates to the technical sector of floor or wall coverings, and relates more particularly to a multilayer structure for producing a floor or wall covering having sound-insulating properties.

The structure according to the invention relates to floor coverings that are laid bonded and has a panel, slab or board form and comprises at least one layer produced from a plastic material, linoleum or rubber.

The present invention also relates to a method for manufacturing such a multilayer structure.

The production of multilayer structures for producing a floor or wall covering having sound-insulating properties is well known from the prior art.

Indeed, sound pollution has become an issue of great importance for society. Numerous stakeholders in the floor coverings market offer multilayer structures comprising backing layers and sound-insulating layers integrated in the multilayer structure or else applied, for example in a roll. The backing layers are in particular produced from crosslinked polyethylene foams and offer a highly satisfactory relationship between sound attenuation and indentation resistance.

This type of multilayer structures, for example in the form of slabs or boards, is for the most part bonded to the floor.

That being said, the major problem with this type of structures lies in the difficulty of bonding them. This is because it is very difficult to bond a polyethylene foam to a backing layer produced from PVC, but also difficult to bond to a concrete or fiber cement slab or as a cover for a floor covering produced from PVC.

From the foregoing, a multilayer structure of the prior art generally comprises:
a wear layer, transparent to light and optionally produced from PVC;
a decorative film;
at least one intermediate layer produced from PVC, optionally plasticized and filled with mineral fillers;
an acoustic backing layer made of crosslinked polyethylene foam, bonded to the back of the intermediate layer and intended to be bonded to the floor.

However, as indicated, the bonding between the intermediate layer made of PVC and the polyethylene foam layer, or the bonding of the lower face of the foam layer to a concrete or fiber cement slab or as a cover for an existing floor covering produced from PVC, is relatively difficult.

This is because conventional acrylic adhesives do not make it possible to effectively bond the polyethylene foam to PVC or to concrete or fiber cement.

Consequently, the resistance to a pull-off test of the backing layer bonded to an intermediate layer made of PVC or to concrete is insufficient with an acrylic adhesive.

In order to solve this problem, it is known to employ multilayer structures using releasable adhesives or tacky material supported by a double-sided film in order to link the backing layer made of polyethylene foam to the intermediate layer made of PVC and optionally to the concrete, to the fiber cement or to a PVC floor covering used as cover.

Alternative adhesives other than acrylic adhesives, for example polyurethane-based adhesives, make it possible to achieve good resistance to delamination, but are more expensive and make the laying method more complex for the flooring installer. In particular, the behavior of this type of adhesive, namely the open time of the adhesive, the tack, etc., is too different from that of a commonly used acrylic adhesive, which is therefore undesirable.

### SUMMARY OF THE INVENTION

One of the aims of the invention is therefore to overcome the abovementioned disadvantages by proposing a multilayer structure for the production of a floor or wall covering which has a sound-insulating backing layer made of crosslinked polyolefin foam, of which the bonding with an acrylic adhesive to an upper layer produced from polyvinyl chloride or as a cover for a floor covering, the surface of which is produced from polyvinyl chloride, is optimal, in particular in order to withstand current pull-off tests.

Another aim of the invention is to provide such a multilayer structure having good indentation resistance values.

To this end, a multilayer structure for producing a floor or wall covering has been developed, which comprises at least one backing layer made of crosslinked polyolefin foam, for example crosslinked polyethylene, giving said structure sound-insulating properties, the backing layer having a lower face intended to be bonded to the floor or wall, and an upper face bonded to an upper layer comprising at least one wear layer. Preferably, the upper layer is produced from a plastic material, preferably thermoplastic, or linoleum or rubber. More preferably, the upper layer is produced from polyvinyl chloride.

According to the invention, at least one of the faces of the backing layer has a surface tension of greater than or equal to 40 mN/m, unlike the prior art, in which the surface tension is approximately 35 mN/m.

The fact that the polyolefin foam is crosslinked, for example by irradiation, makes it possible to create structural chemical bonds. This makes it possible to improve the temperature resistance as well as the mechanical compressive strength, or else the moisture resistance. In particular, a crosslinked polyethylene foam makes it possible to obtain a good compromise between the mechanical compressive strength, in particular to withstand the traffic that the floor covering is subjected to, and the acoustic properties of the floor covering.

The fact that the surface tension of one of the faces of the backing layer is greater than or equal to 40 mN/m makes it possible to improve the bonding, in particular with polyurethane-based adhesives, for example of the well-known “hot melt” type, with adhesives well-known under the acronym PSA for “Pressure Sensitive Adhesives”, but above all with acrylic-based adhesives.

Advantageously, and in order to optimize the bonding of the lower face of the backing layer to a concrete or fiber cement slab or as a cover for a floor covering produced from PVC, said lower face has a surface tension of greater than or equal to 40 mN/m.

Advantageously, and in order to optimize the bonding of the upper face of the backing layer to an upper layer produced from PVC, said upper face has a surface tension of greater than or equal to 40 mN/m.

According to a particular embodiment, and in order to obtain the desired surface tension, the upper face and/or the lower face of the backing layer have undergone a surface treatment by fluorination. In other words, this means that the surface of the upper face, and optionally lower face, of the backing layer, for example the first 10 nanometers of thickness starting from said treated face, comprise fluorine atoms, for example at a content of greater than 3%, preferably greater than 5%. A fluorine content of greater than 3% makes it possible to achieve delamination values of greater than approximately 0.6 daN/cm. A fluorine content of greater than 5% makes it possible to achieve delamination values of greater than approximately 0.8 daN/cm. The method of measuring the delamination is defined by standard NF EN ISO 24345.

During the surface treatment by fluorination, the reactivity of the fluorine gas on the surface of the treated face of the backing layer leads to substitution of hydrogen atoms by fluorine atoms, thereby optimizing the adhesion of the adhesive.

In order to improve the sound-insulating properties and to retain good indentation resistance values, the backing layer has a thickness of between 0.5 and 2 mm, and preferably equal to 1 mm.

Still with the same aim of improving the sound-insulating and indentation resistance properties, the backing layer has a density of between 70 and 120 kg/m³ or even between 80 and 120 kg/m³, and preferably equal to 95 kg/m³.

Starting from this concept, the multilayer structure may have several configurations.

The multilayer structure comprises a wear layer, optionally produced based on polyvinyl chloride. The backing layer can be directly bonded to this wear layer.

According to another embodiment, the wear layer is transparent to visible light and linked to a decorative film.

According to yet another embodiment, the multilayer structure comprises one or more intermediate layers produced from polyvinyl chloride, on one side linked to the wear layer, which integrates or does not integrate a decorative film, and on the other side bonded to the backing layer.

According to a particular embodiment, the intermediate layer is produced from polyvinyl chloride, and is optionally plasticized, and optionally comprises mineral fillers.

The upper layer and/or the wear layer and/or the intermediate layers are generally produced from a plastic material, preferably thermoplastic, or linoleum or rubber.

In particular, materials which can be used depending on the mechanical properties sought for producing the upper layer and/or the wear layer and/or the intermediate layers are in particular polyolefins, thermoplastic copolyesters, thermoplastic polyamides, polyvinyl chloride (PVC), polyvinyl butyral (PVB), polylactic acid (PLA), polyethylene terephthalate (PET), polymethyl methacrylate (PMMA), polypropylene (PP), polyethylene glycol (PETG), thermoplastic polyurethanes (TPU), poly(ethylene-vinyl acetate) (EVA), poly(ethylene-methyl acrylate) (EMA), poly(ethylene-butyl acrylate) (EBA), poly(ethylene-ethyl acrylate) (EEA), alone or in mixtures.

The present invention also relates to a method for manufacturing a multilayer structure for producing a floor or wall covering, the structure comprising a backing layer made of crosslinked polyolefin foam, for example crosslinked polyethylene, giving the multilayer structure sound-insulating properties. The backing layer has a lower face intended to be bonded to the floor or wall, and an upper face bonded to an upper layer produced from polyvinyl chloride.

According to the invention, the method consists, before bonding of the upper face of the backing layer to the upper layer, of said upper face undergoing a treatment that increases its surface tension to a level greater than or equal to 40 mN/m.

Likewise, and according to a particular embodiment, in particular when the multilayer structure is being bonded to an existing PVC floor covering, concrete or fiber cement, the lower face of the backing layer undergoes, before bonding, a surface treatment that increases its surface tension to a level greater than or equal to 40 mN/m.

According to particular embodiments, the treatment consists of a surface treatment by fluorination, such as an oxyfluorination or a perfluorination, or else consists of a corona treatment.

### BRIEF DESCRIPTION OF THE SEVERAL VIEWS OF THE DRAWINGS

Other features and advantages will be clearer from the following description, provided as a non-limiting example, in reference to the appended figures, in which:

FIG. 1 is a schematic sectional depiction of a first embodiment of a multilayer structure according to the invention;

FIG. 2 is a schematic depiction similar to that of FIG. 1, illustrating a second embodiment of the invention;

FIG. 3 is a schematic depiction similar to that of FIG. 1, illustrating a third embodiment of the invention.

### DESCRIPTION OF SPECIFIC EMBODIMENTS OF THE INVENTION

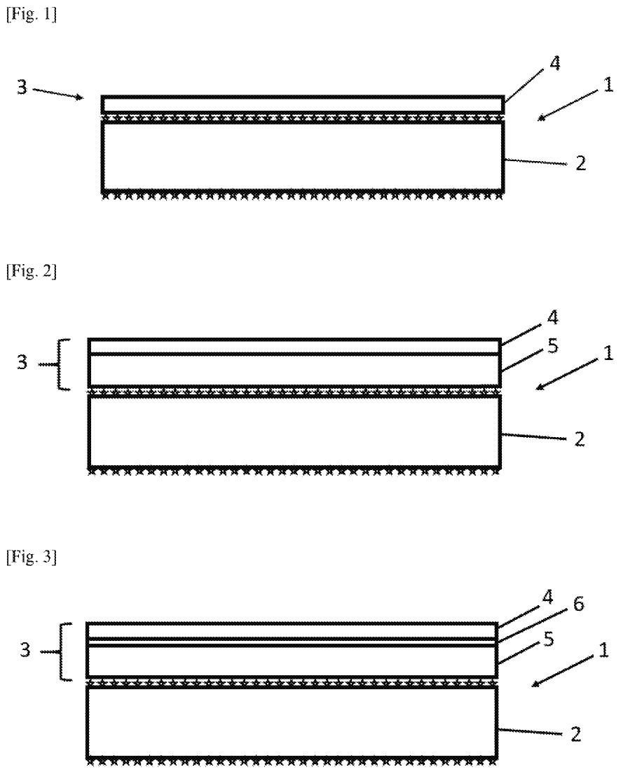

With reference to FIGS. 1 to 3, the invention relates to a multilayer structure (1) for producing a floor or wall covering having sound-insulating properties.

To this end, and in a known manner, the multilayer structure (1) comprises at least one backing layer (2) made of crosslinked polyolefin foam, giving the structure sound-insulating properties, which structure comprises a lower face intended to be bonded to the floor or to the wall.

The backing layer (2) made of crosslinked polyolefin foam, for example in particular made of crosslinked polyethylene foam, preferably has a thickness of between 0.5 and 2 mm, for example 1 mm, and a density of between 70 kg/m³ and 120 or even between 80 and 120 kg/m³, for example equal to 95 kg/m³.

From the foregoing, the backing layer (2), associated with an upper layer (3) comprising a wear layer (4) produced from a plastic material, linoleum or rubber, enables the multilayer structure (1) to have good performance in terms of sound insulation and indentation resistance.

The upper layer (3) preferably has a thickness of between 1 and 6 mm. More preferably, the upper layer (3) has a thickness of between 1 and 3 mm in order to have good wear resistance while limiting the cost of manufacturing the multilayer structure (1).

In a known manner, the upper face of the backing layer (2) is bonded to the upper layer (3) produced from polyvinyl chloride.

According to the invention, and in order to facilitate the bonding operation, with an acrylic-based adhesive for example, and in particular in order to guarantee optimal resistance to the current pull-off test, said upper face of the backing layer (2) has a surface tension of greater than or equal to 40 mN/m. The surface tension is defined according to standard ISO 8296-2003.

Likewise, in order to facilitate the bonding of the lower face of the backing layer (2), in particular when it is being bonded to concrete or fiber cement, said lower face of the backing layer (2) also has a surface tension of greater than or equal to 40 mN/m.

In order to obtain this surface tension value, several solutions are possible.

According to a first embodiment, a surface treatment is carried out on the upper face, optionally on the lower face, of the backing layer (2), increasing their surface tension to a level greater than or equal to 40 mN/m.

For example, this surface treatment may consist of a surface treatment by fluorination, such as an oxyfluorination or a perfluorination.

Carrying out such a process for surface treatment by fluorination is visible on the final multilayer structure (1) since the thickness of the backing layer (2), and for example the first ten nanometers of thickness of the treated face, comprise fluorine atoms, for example at a content of greater than 3%, preferably greater than 5%.

During the fluorination process, the reactivity of the fluorine gas on the surface of the crosslinked polyolefin foam, or more specifically of the crosslinked polyethylene foam, leads to the substitution of hydrogen atoms by fluorine atoms, thereby improving the adhesion of the adhesive, and in particular of an acrylic-based adhesive.

In order to verify the fluorine content on the treated face, said face is for example analyzed by X-ray photoelectron spectroscopy.

The analytical conditions are as follows:

XPS on NOVA KRATOS apparatus

ANALYTICAL CONDITIONS: Source: monochromatic Al Kα. With charge compensation. 150 watts for general spectra and 225 watts for high-resolution spectra. Area analyzed: 300 μm×700 μm. Detection angle: normal (θ=0°). Analyzed depth less than 10 nm in normal detection.

In these conditions, the analysis made it possible to detect, in the first 10 nanometers of the treated face, a content of fluorine atoms equal to 8.2%.

This fluorine content of 8.2% makes it possible for the treated face of the backing layer (2) to have a surface tension of greater than 40 mN/m, and in particular a surface tension of 52 mN/m. The method of measuring the surface tension is defined according to standard ISO 8296-2003.

In order to check the adhesion of the backing layer (2), tests were carried out with upper and lower faces of the backing layer (2) treated by fluorination and having a surface tension of 52 mN/m.

The tests carried out consist of measurements of pulling off the backing layer (2) bonded, on one side, to an upper layer (3) of plasticized PVC and filled with mineral fillers, and bonded, on the other side, to a fiber cement floor, in comparison with a backing layer (2) bonded under the same conditions but not treated with fluorine, i.e. having a surface tension of approximately 35 mN/m.

The pull-off test of the assembly of the multilayer structure (1) on the fiber cement support gives a mean force value of 0.1 daN/cm for the structure comprising an untreated backing layer (2).

The test carried out with a multilayer structure (1) comprising a backing layer (2), the upper and lower faces of which are treated, gives a mean force value of 1.3 daN/cm.

Consequently, it appears that the multilayer structure (1) comprising a backing layer (2) treated according to the invention has good adhesion, noting that the minimum value for the pull-off force required by the current standards must be 0.6 daN/cm.

Thus, the present invention makes it possible to facilitate the bonding of the backing layer (2) to an upper layer (3) of PVC, in particular by means of a conventional acrylic adhesive, while guaranteeing optimal bonding, and also easy laying of the assembly of the multilayer structure (1) since bonding becomes possible on a concrete or fiber cement slab, without changing processes or products conventionally used by flooring installers.

In order to obtain a surface tension of greater than or equal to 40 mN/m, another solution consists in subjecting the upper face of the backing layer, and optionally the lower face, to a corona treatment. Corona treatment consists of emitting a high-frequency electrical discharge toward the treated surface. It makes it possible to obtain a very high level of oxidation of the surface and to modify the wettability thereof in order to facilitate the attachment of the adhesive, in particular acrylic-based.

However, the effect of the corona treatment tends to degrade in a few weeks. The corona treatment is therefore rather used to bond the upper face of the backing layer (2) to the upper layer (3).

Several embodiments are conceivable for the multilayer structure (1), depending on the desired application.

For example, and with reference to FIG. 1, the upper layer (3) may in particular consist of a single wear layer (4) produced from polyvinyl chloride, optionally plasticized, and optionally filled with mineral fillers.

According to one embodiment, in particular illustrated in FIG. 2, the upper layer (3) may consist of a wear layer (4) linked to an intermediate layer (5), itself produced from PVC, optionally plasticized, optionally filled with mineral fillers.

According to another embodiment, in particular illustrated in FIG. 3, the upper layer (3) consists of a wear layer (4) linked to an decorative film (6) and to an intermediate layer (5), itself produced from polyvinyl chloride, optionally plasticized, optionally filled with mineral fillers. According to this embodiment, the wear layer (4) preferably has a thickness of between 0.3 and 1 mm. This makes it possible to adapt the wear layer depending on the resistance to traffic desired for the majority of applications, while limiting the manufacturing cost of the multilayer structure (1).

The invention lies in the fact that the upper face of the backing layer (2), intended to be in contact with PVC, has a surface tension of greater than or equal to 40 mN/m and, if the backing layer (2) is intended to be bonded to concrete or fiber cement, or any other material to which acrylic-based adhesive has mediocre adhesion, the lower face of the backing layer (2) also comprises a surface tension of greater than or equal to 40 mN/m.

It emerges from the foregoing that the invention does indeed provide a multilayer structure (1) for producing floor coverings, which has sound-insulating properties, while making it possible to optimize bonding with an acrylic adhesive of a crosslinked polyolefin foam to PVC, concrete or fiber cement, while making it possible to withstand current pull-off tests and while having a good indentation resistance.

What is claimed is:

1. A multilayer structure (1) for producing a floor or wall covering, the structure comprising at least one backing layer (2) made of crosslinked polyolefin foam, giving the structure sound-insulating properties, the backing layer (2) having a lower face intended to be bonded to the floor or wall, and an upper face bonded to an upper layer (3) produced from a plastic material, linoleum or rubber, characterized in that at least one of the faces of the backing layer (2) has a surface tension of greater than or equal to 40 mN/m.

2. The structure according to claim 1, characterized in that the lower face of the backing layer (2) has a surface tension of greater than or equal to 40 mN/m.

3. The structure according to claim 1, characterized in that the upper face of the backing layer (2) has a surface tension of greater than or equal to 40 mN/m.

4. The structure according to claim 1, characterized in that the upper face and/or the lower face have undergone a surface treatment by fluorination.

5. The structure according to claim 1, characterized in that the backing layer (2) has a thickness of between 0.5 and 2 mm, and preferably equal to 1 mm.

6. The structure according to claim 1, characterized in that the backing layer (2) has a density of between 70 and 120 kg/m³, and preferably equal to 95 kg/m³.

7. The structure according to claim 1, characterized in that the upper layer (3) is produced from polyvinyl chloride.

8. The structure according to claim 1, characterized in that it comprises a wear layer (4), transparent to visible light and linked to a decorative film (6).

9. The structure according to claim 7, characterized in that it comprises an intermediate layer (5) produced from polyvinyl chloride, bonded to the backing layer (2).

10. The structure according to claim 9, characterized in that the intermediate layer (5) produced from polyvinyl chloride is plasticized and comprises mineral fillers.

11. A method for manufacturing a multilayer structure (1) for producing a floor or wall covering, the multilayer structure (1) comprising a backing layer (2) made of crosslinked polyolefin foam, giving the structure sound-insulating properties, the backing layer (2) having a lower face intended to be bonded to the floor or wall, and an upper face bonded to an upper layer (3) produced from polyvinyl chloride, characterized in that, before bonding of the upper face of the backing layer (2) to the upper layer (3), said upper face undergoes a surface treatment that increases its surface tension to a level greater than or equal to 40 mN/m.

12. The method according to claim 11, characterized in that the lower face of the backing layer (2) also undergoes a surface treatment that increases its surface tension to a level greater than or equal to 40 mN/m.

13. The method according to claim 11, characterized in that the surface treatment consists of a surface treatment by fluorination.

14. The method according to claim 11, characterized in that the surface treatment consists of a corona treatment.

15. The structure according to claim 2, characterized in that the upper face of the backing layer (2) has a surface tension of greater than or equal to 40 mN/m.

16. The structure according to claim 2, characterized in that the upper face and/or the lower face have undergone a surface treatment by fluorination.

17. The structure according to claim 3, characterized in that the upper face and/or the lower face have undergone a surface treatment by fluorination.

18. The structure according to claim 8, characterized in that it comprises an intermediate layer (5) produced from polyvinyl chloride, bonded to the backing layer (2).
